(19) United States
(12) Patent Application Publication
(10) Pub. No.: US 2019/0286885 A1
(43) Pub. Date: Sep. 19, 2019

(54) Face identification system for a mobile device

(71) Applicant: Kneron Inc., San Diego, CA (US)

(72) Inventor: Chun-Chen Liu, San Diego, CA (US)

(21) Appl. No.: 15/919,223

(22) Filed: Mar. 13, 2018

(51) Int. Cl. G06K 9/00; G06F 21/32; G06N 3/04

(52) U.S. Cl. CPC G06K 9/00288; G06N 3/0454; G06F 21/32

(57) ABSTRACT

A face identification system for a mobile device includes a housing and a central processing unit within the housing, the central processing unit configured to unlock or not unlock the mobile device according to a comparison result. The face identification system is disposed within the housing. The face identification system includes a 3D structured light emitting device configured to emit a three-dimensional structured light signal to an object external to the housing. A first neural network processing unit outputs a comparison result to the central processing unit according to processing of an inputted sampled signal. A sensor is configured to perform three-dimensional sampling of the three-dimensional structured light signal as reflected by the object and input the sampled signal directly to the first neural network processing unit.

### BACKGROUND OF THE INVENTION

### 1. Field of the Invention

This application relates to a face identification system for a mobile device, more particularly to an integrated face identification system based only on 3D data that may be used in a mobile device.

### 2. Description of the Prior Art

For years, various forms of face identification (ID) in a mobile device suffered limited success dues to accuracy and security concerns. Recent technologies have improved upon these drawbacks at least partly due to the introduction of a three-dimensional (3D) sensor to complement a two-dimensional (2D) camera. Broadly speaking, a 2D image captured from the 2D camera is firstly compared with a stored 2D image of an authorized user to see if it is really the authorized user. If confirmed, data from the 3D sensor is reconstructed using a Re-Configurable Instruction Cell Array (RICA) into a 3D image to make sure the captured image is of the authorized user, not a picture or likeness of the authorized user.

Referring to FIG. 1, the conventional way of performing this process is for a mobile device 100 to use a face identification system 20. Decoded signals received from the 2D camera 50 and from the 3D sensor 40 are transmitted to a system-on-a-chip (SoC), which contains the main processor 30 of the mobile device 100. The processor 30 receives the 2D and 3D signals via data paths 70, 80 and analyzes them as above using a secure area (Trust Zone), RICA, and a neural-network processing unit 60 of the SoC to determine whether the face observed belongs to the owner of the device 100.

While the conventional system works fairly well, there are some drawbacks. Firstly, working memory in the secure area of the SoC is usually very small. This worked well for fingerprint data, but is not overly sufficient for reconstruction of 3D images. Secondly, the RICA, necessary for 3D reconstruction in the conventional device, is quite expensive. In addition, thirdly, there is a risk of a hacker obtaining sensitive data from the signals as they are transmitted from the camera and sensor to the SoC.

### SUMMARY OF THE INVENTION

It is an objective of the instant application to provide a face identification system for a mobile device that solves the prior art problems of insufficient memory, costs, and security.

Toward this goal, a novel mobile device is proposed. The mobile device comprises a housing. A central processing unit is disposed within the housing and is configured to unlock or not unlock the mobile device according to a comparison result. A face identification system is disposed within the housing and comprises

a projector configured to project a pattern onto an object external to the housing, a neural network processing unit configured to output the comparison result to the central processing unit according to processing of an inputted sampled signal, and a sensor configured to perform three dimensional sampling of the pattern as reflected by the object and input the sampled signal directly to the neural network processing unit.

The projector may comprise a three-dimensional structured light emitting device configured to emit at least one three-dimensional structured light signal to the object. The three-dimensional structured light emitting device may comprise a near infrared sensor (NIR sensor) configured to detect an optical signal outside a visible spectrum reflected by the object.

The face identification system may further comprise a memory coupled to the neural network processing unit and configured to save three-dimensional face training data. The neural network processing unit may be configured to output the comparison result to the central processing unit according to a comparison of the sampled signal and the three-dimensional face training data. The face identification system may comprise a microprocessor coupled to the neural network processing unit and to the memory, the microprocessor configured to operate the neural network processing unit and the memory.

Another mobile device may include a housing with a central processing unit within the housing, the central processing unit configured to unlock or not unlock the mobile device according to a comparison result. A face identification system is disposed within the housing. The face identification system may comprise a 3D structured light emitting device configured to emit at least one 3D structured light signal to an object external to the housing, a first neural network processing unit configured to output the comparison result to the central processing unit according to processing of an inputted sampled signal, and a sensor configured to perform 3D sampling of the at least one three-dimensional structured light signal as reflected by the object and input the sampled signal directly to the first neural network processing unit.

The face identification system may further comprise a 2D camera configured to output a captured 2D image and a second neural network processing unit coupled to directly receive the captured 2D image and the sampled signal. The second neural network processing unit may be configured to generate a reconstructed 3D image utilizing the captured 2D image and the sampled signal and output the reconstructed 3D image to the central processing unit.

The three-dimensional structured light emitting device may comprise a near infrared sensor (NIR sensor) configured to detect an optical signal outside a visible spectrum reflected by the object. The face identification system may comprise a memory coupled to the first neural network processing unit and configured to save three-dimensional face training data and is further configured to output the comparison result to the central processing unit according to a comparison of the sampled signal and the three-dimensional face training data.

The face identification system may further comprise a microprocessor coupled to the first neural network processing unit and to the memory, configured to operate the first neural network processing unit and the memory.

An integrated face identification system comprises a neural network processing unit having a memory storing face training data, the neural network processing unit may be configured to input a sampled signal and the face training data and output a comparison result. A 3D structured light emitting device configured to emit a 3D structured light signal to an external object, the 3D structured light emitting device comprising a near infrared sensor and is configured to perform 3D sampling of the 3D structured light signal as reflected by the object and input the sampled signal directly to the neural network processing unit. The integrated face identification system may further comprise a 2D camera configured to output a captured 2D image and a second neural network processing unit coupled to directly receive the captured 2D image and the sampled signal and configured to generate a reconstructed 3D image utilizing the captured two-dimensional image and the sampled signal and output the reconstructed three-dimensional image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional face identification system in a mobile device.

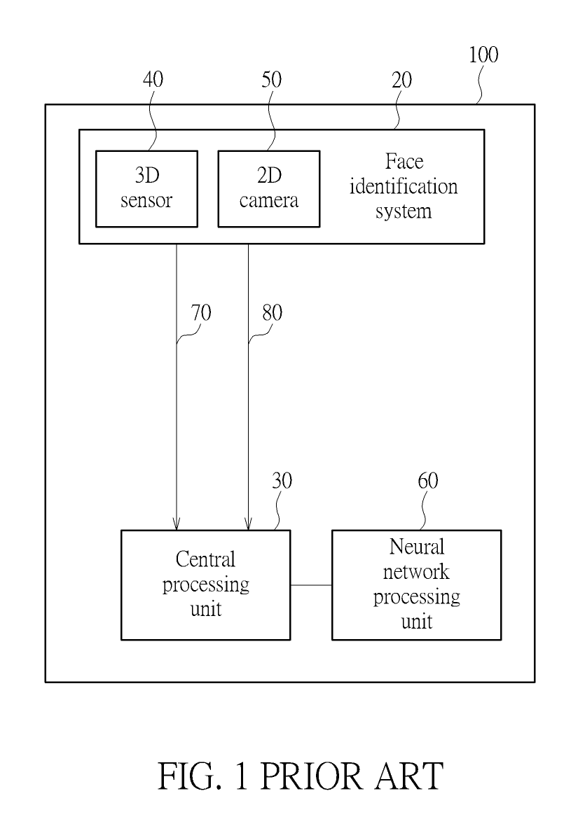

FIG. 2 is a block diagram of a face identification system for a mobile device according to an embodiment of the application.

FIG. 3 is a block diagram of face identification system for a mobile device according to an embodiment of the present application.

### DETAILED DESCRIPTION

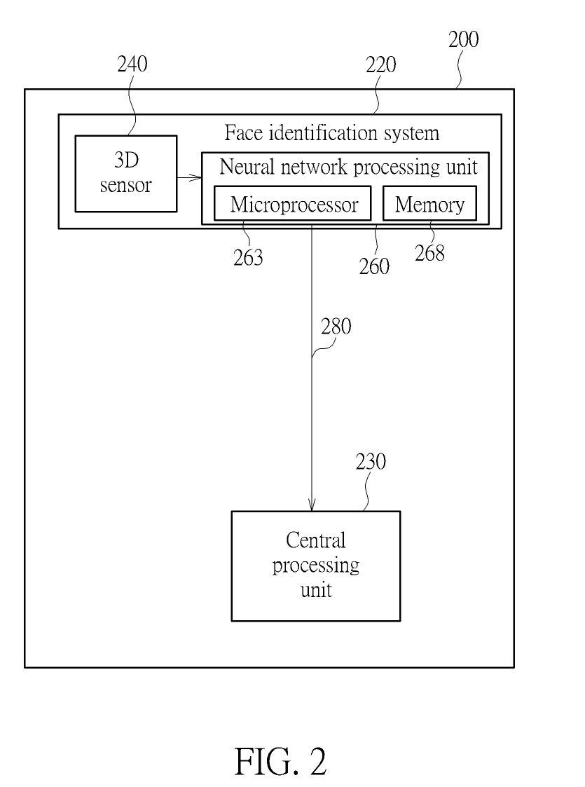

The prior art usage of a RICA to reconstruct a 3D image for face identification is expensive, time consuming, and power consuming. FIG. 2 illustrates a mobile device 200 having a novel structure for a face identification system 220 without these drawbacks.

As previously stated, the prior art uses a two-step system. Firstly a 2D image is captured and compared with a reference image. If a match is found, data from a 3D sensor is then combined with the 2D image using a RICA to reconstruct a 3D image of the scanned face. This reconstructed 3D image is then checked for device authorization.

The inventor has realized that face identification can be achieved with excellent results by comparing data from a 3D sensor directly with saved reference data, without the need for a 2D camera and without requiring 3D reconstruction of a scanned face.

Face identification system 220 includes a 3D sensor, preferably a three-dimensional structured light sensor, which includes a projector or light emitting device configured to emit at least one three-dimensional structured light signal to an object external to the housing of the mobile device 200. The three-dimensional structured light signal may be a pattern comprising grids, horizontal bars, or a large number of dots, 30,000 dots as an example.

A 3D object, such as a face, distorts the pattern reflected back to the 3D sensor 240 and the 3D sensor 240 determines depth information from the distorted pattern. Because of the fineness of the pattern and the fact that each face is at least a little structurally different, the depth information from the distorted pattern is for all purposes unique for a given face. The 3D sensor 240 is configured to perform 3D sampling of the pattern as reflected by the object and input the sampled signal directly to the neural network processing unit 260.

The neural network processing unit 260 comprises a neural network, memory 268, and a microprocessor 263. The neural network may be any kind of artificial neural network that can be trained to recognize a specific condition, such as recognizing a particular face. In this specific case, the neural network has been trained to recognize when given depth information from the distorted pattern corresponds to a given face, a face authorized to unlock the mobile device 200. The neural network may reside in the memory 268 or elsewhere within the neural network processing unit 260 according to design considerations. The microprocessor 263 may control operation of the neural network processing unit 260 and memory 268.

When the neural network is given depth information from the distorted pattern that corresponds to an authorized face, a comparison result signal is sent via signal path 280 to the central processing unit 230, informing the central processing unit 230 that a scanned face matches an authorized face and the mobile device 200 should be unlocked. The central processing unit 230 unlocks the mobile device 200 when this “match” signal is received, and does not unlock the mobile device 200 (if currently locked) when this “match” signal is not received.

The comparison result, informing the central processing unit 230 whether the mobile device 200 should be unlocked, may be of any type, such as a binary on/off signal or a high/low signal. In some embodiments, a different kind of signal may be utilized that also may not contain any depth information.

At least a portion of the memory 268 may be configured to store three-dimensional face training data. The three-dimensional face training data represents an authorized face with which the neural network was trained to recognize. At least because signal path 280 is one way, from the face identification unit 220 to the central processing unit 230, the memory 268 is secure enough to comprise the three-dimensional face training data without requiring additional security measures.

The above embodiment is complete in its ability to provide secure, fast face identification for a mobile device. The face identification system 220 may be converted for use with a mobile device that also requires a 3D reconstruction of a face or for a purpose other than unlocking the mobile device, for example to overlay a user's face onto an avatar in a game being played on the mobile device or across a network.

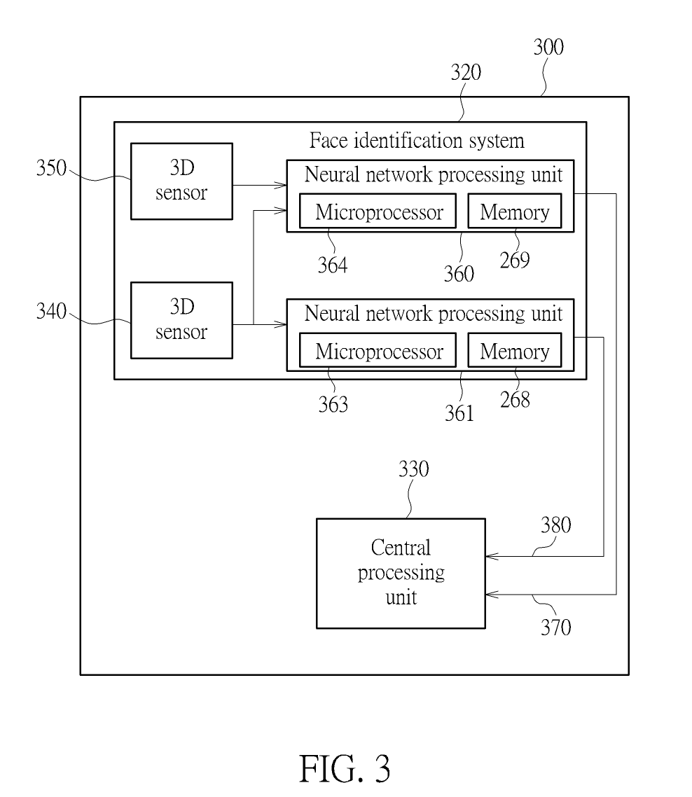

FIG. 3 illustrates such a conversion. Mobile device 300 comprises face identification system 320, which like face identification system 220 of the previous embodiment includes a 3D sensor 340, preferably a three-dimensional structured light sensor, which includes a projector or light emitting device configured to emit at least one three-dimensional structured light signal to an object external to the housing of the mobile device 300. The three-dimensional structured light signal may be a pattern comprising grids, horizontal bars, or a large number of dots, 30,000 dots as an example. The 3D sensor 340 is configured to perform 3D sampling of the pattern as reflected by the object and input the sampled signal directly to the neural network processing unit 361.

The neural network processing unit 361 may comprise a neural network, the memory 268, and the microprocessor 263. The neural network may be any kind of artificial neural network that can be trained to recognize a specific condition and may reside in the memory 268 or elsewhere within the neural network processing unit 361. The microprocessor 363 may control operation of the neural network processing unit 361 and memory 268. At least a portion of the memory 268 may be configured to store three-dimensional face training data.

Like face identification system 220 of the previous embodiment, when the neural network is given depth information that corresponds to an authorized face, a comparison result signal is sent via signal path 380 to the central processing unit 230. The central processing unit 330 unlocks or does not unit the mobile device 300 according to the comparison result signal.

Face identification system 360 may further comprise a two dimensional camera 350 configured to capture a 2D image of the object and output a captured 2D image and the sampled signal directly to a second neural network processing unit 364. The second neural network processing unit 364 may comprise a neural network, a memory 269, and a microprocessor 263. The neural network may be any kind of artificial neural network designed to reconstruct a 3D image given the captured 2D image from the 2D camera 350 and the sampled signal from the 3D sensor 340. The neural network processing unit 360 is configured to output the captured 2D image or the reconstructed 3D image via signal path 370 to the central processing unit 330 according to demand. The neural network may reside in the memory 269 or elsewhere within the neural network processing unit 360.

In some embodiments, microprocessors 363 and 364 are a same microprocessor shared as needed by the first and second neural network processing units. Similarly, in some embodiments, memories 268 and 269 are a same memory shared as needed by the first and second neural network processing units.

In accordance with the description above, an integrated face identification system may comprise a neural network processing unit having a memory storing face training data, the neural network processing unit configured to input a sampled signal and the face training data and output a comparison result. A three-dimensional structured light emitting device may be configured to emit a three-dimensional structured light signal to an external object, the three-dimensional structured light emitting device comprising a near infrared sensor and may be configured to perform three dimensional sampling of the three-dimensional structured light signal as reflected by the object and input the sampled signal directly to the neural network processing unit.

The integrated face identification system may further comprise a two-dimensional camera configured to output a captured two-dimensional image and a second neural network processing unit coupled to directly receive the captured two-dimensional image and the sampled signal and configured to generate a reconstructed three-dimensional image utilizing the captured two-dimensional image and the sampled signal and output the reconstructed three-dimensional image.

In summary, the disclosed face identification system provides quick face identification without the prior art needs of a restricted size trust zone and without the need for a costly RICA for 3D reconstruction. Face identification is based on only the sampled signal, and provides excellent results. The unique disclosed structure makes the stored training data secure enough to prevent hacking, yet simplifies the identification process while retaining the ability to provide a 3D image when required.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile device comprising:
a housing;
a central processing unit within the housing, the central processing unit configured to unlock or not unlock the mobile device according to a comparison result;
a face identification system within the housing, the face identification system comprising:
a projector configured to project a pattern onto an object external to the housing;
a neural network processing unit configured to output the comparison result to the central processing unit according to processing of an inputted sampled signal; and
a sensor configured to perform three dimensional (3D) sampling of the pattern as reflected by the object and input the sampled signal directly to the neural network processing unit.

2. The mobile device of claim 1 wherein the projector comprises a three-dimensional structured light emitting device configured to emit at least one three-dimensional structured light signal to the object.

3. The mobile device of claim 2 wherein the three-dimensional structured light emitting device comprises a near infrared sensor (NIR sensor) configured to detect an optical signal outside a visible spectrum reflected by the object.

4. The mobile device of claim 1 wherein the face identification system further comprises a memory coupled to the neural network processing unit and configured to save three-dimensional face training data.

5. The mobile device of claim 4 wherein the neural network processing unit is further configured to output the comparison result to the central processing unit according to a comparison of the sampled signal and the three-dimensional face training data.

6. The mobile device of claim 4 wherein the face identification system further comprises a microprocessor coupled to the neural network processing unit and to the memory, the microprocessor configured to operate the neural network processing unit and the memory.

7. The mobile device of claim 1 wherein the face identification system further comprises a two dimensional (2D) camera configured to capture a 2D image of the object and output a captured 2D image directly to a second neural network processing unit different from the neural network processing unit.

8. The mobile device of claim 7 wherein the second neural network processing unit is configured to process the captured 2D image and output a result to the central processing unit.

9. The mobile device of claim 8 wherein the sensor is further configured to output the sampled signal directly to the second neural network processing unit.

10. The mobile device of claim 9 wherein the second neural network processing unit is further configured to reconstruct a 3D image utilizing the captured 2D image and the sampled signal.

11. An integrated face identification system comprising:
a neural network processing unit comprising a memory storing face training data, the neural network processing unit configured to input a sampled signal and the face training data and output a comparison result; and
a three-dimensional structured light emitting device configured to emit a three-dimensional structured light signal to an external object, the three-dimensional structured light emitting device comprising a near infrared sensor and is configured to perform three dimensional sampling of the three-dimensional structured light signal as reflected by the object and input the sampled signal directly to the neural network processing unit.

12. The integrated face identification system of claim 11 further comprising:
a two-dimensional camera configured to output a captured two-dimensional image; and
a second neural network processing unit, different from the neural network processing unit, coupled to directly receive the captured two-dimensional image and the sampled signal and configured to generate a reconstructed three-dimensional image utilizing the captured two-dimensional image and the sampled signal and output the reconstructed three-dimensional image.

13. The integrated face identification system of claim 11 wherein the comparison result is a binary signal.

14. A mobile device comprising:
a housing;
a central processing unit within the housing, the central processing unit configured to unlock or not unlock the mobile device according to a comparison result;
a face identification system within the housing, the face identification system comprising:
a three-dimensional (3D) structured light emitting device configured to emit a three-dimensional structured light signal to an object external to the housing;
a first neural network processing unit configured to output the comparison result to the central processing unit according to processing of an inputted sampled signal;
a sensor configured to perform three dimensional sampling of the three-dimensional structured light signal as reflected by the object and input the sampled signal directly to the first neural network processing unit;
a two-dimensional (2D) camera configured to output a captured 2D image; and
a second neural network processing unit, different from the first neural network processing unit, coupled to directly receive the captured 2D image and the sampled signal and configured to generate a reconstructed 3D image utilizing the captured 2D image and the sampled signal and output the reconstructed 3D image to the central processing unit.

15. The mobile device of claim 14 wherein the three-dimensional structured light emitting device comprises a near infrared sensor (NIR sensor) configured to detect an optical signal outside a visible spectrum reflected by the object.

16. The mobile device of claim 14 wherein the face identification system further comprises a memory coupled to the first neural network processing unit and configured to save three-dimensional face training data.

17. The mobile device of claim 16 wherein the first neural network processing unit is further configured to output the comparison result to the central processing unit according to a comparison of the sampled signal and the three-dimensional face training data.

18. The mobile device of claim 16 wherein the face identification system further comprises a microprocessor coupled to the first neural network processing unit and to the memory, the microprocessor configured to operate the first neural network processing unit and the memory.
